(19) United States
(12) Patent Application Publication
(10) Pub. No.: US 2025/0019165 A1
(43) Pub. Date: Jan. 16, 2025

(54) VEHICLE GATE ARRANGEMENT WITH FIRST AND SECOND SHUTTERS, SYSTEM COMPRISING THE ARRANGEMENT AND METHOD OF OPERATION

(71) Applicant: Autostore Technology AS, Nedre Vats (NO)

(72) Inventors: Trond Austrheim, Etne (NO); Ivar Fjeldheim, Haugesund (NO)

(73) Assignee: Autostore Technology AS, Nedre Vats (NO)

(21) Appl. No.: 18/708,137

(22) PCT Filed: Nov. 7, 2022
(86) PCT No.: PCT/EP2022/080916

§ 371 Date: May 7, 2024

(30) Foreign Application Priority Data
Nov. 11, 2021 (NO) 20211360

(51) Int. Cl. B65G 1/04; E05F 15/00; E06B 9/02; F16P 1/00

(52) U.S. Cl. CPC B65G 1/0464; E05F 15/00; E06B 9/02; F16P 1/00; E05Y 2201/668; E05Y 2900/11

(57) ABSTRACT

A storage system includes a first area, a second area, a vehicle, and a vehicle gate arrangement. The first area includes a framework structure including upright members and a two-dimensional first rail system arranged across a top of framework structure. The first rail system includes a first set of parallel rails arranged to guide movement of vehicles in a first direction across the top of the frame structure, and a second set of parallel rails arranged perpendicular to the first set of rails to guide movement of the vehicles in a second direction across the top of the framework structure that is perpendicular to the first direction. The first and second sets of parallel rails divide the first rail system into a plurality of access openings in the first rail system for allowing lifting and lowering of a storage container between a position above the first rail system and a position below the first rail system. The vehicle operable on the first rail system. The vehicle includes a first set of wheels for driving in the first direction and a second set of wheels for driving in the second direction. The second area includes a second rail system. The vehicle gate arrangement controls passage of the vehicle between the first area and the second area via a connecting rail system. The vehicle gate arrangement includes a space for accommodating the vehicle; a first shutter for separating the space and the first area; and a second shutter for separating the space and the second area. Both the first shutter and the second shutter are each actuatable between: an open position which allows passage of the vehicle therethrough; and an obstructing position which restricts passage of the vehicle therethrough. The first shutter and the second shutter are coupled to each other for synchronous movement such that one shutter moves in one direction with respect to a first opening and the other shutter moves in an opposite direction with respect to a second opening, and wherein the first shutter and/or the second shutter is in the respective obstructing position at any time.

The present invention relates to a storage system comprising a first area and a second area, wherein the first area is linked to the second area for passage of a remotely operated vehicle by a vehicle gate arrangement comprising a first shutter and a second shutter to regulate the passage of the vehicle between the first and the second area.

In particular, the first area can be a storage area and the second area can be a service area where human operators operate.

### BACKGROUND AND PRIOR ART

FIG. 1 discloses a prior art automated storage and retrieval system 1 with a framework structure 100 and FIGS. 2, 3 and 4A disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4A two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4A indicated with reference number 304,404. The gripping device of the container handling device 201 is located within the vehicle body 201a in FIG. 2 and is thus not shown. The lifting device may further comprise a lifting frame 27 suspended from lifting bands 25. The lifting bands 25 may provide power and communication between the container handling vehicle and the lifting frame 27. The lifting frame 27 may comprise gripping engaging devices 26 for connection to gripping recesses of a storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4A and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

A storage system may also use port columns 119,120 to transfer a storage container between the rail system 108 on top of the framework structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

In case a container handling vehicle malfunctions, it is normal in today's solutions to have a door or shutter that slides upwards or sideways between a storage area and a service area for passing of vehicles therethrough. The only safety measure is that the door needs to be closed within 3 minutes. If the door is not closed within this time window, the system will shut down. It is a problem that when a door or shutter is open, personnel could potentially climb unhindered through the door from the service area and into the storage area where the container handling vehicles operate. Another potential problem is that it is possible that robots can drive through the robot door during the 3 minutes the door is open because there is no additional safety barrier.

One objective of the invention is to solve at least some of the drawbacks related to prior art solutions.

In particular, it is an objective of the invention to provide a solution for controlled passing of vehicles between a first area at one side of a gate arrangement and a second area on a second side of the gate arrangement without causing an accidental shutting down of the storage system and minimize risk of injury to operators.

### SUMMARY OF THE INVENTION

The present invention is set forth and characterized in the independent claims, while the dependent claims describe other characteristics of the invention.

The invention provides a secure system and method for transferring a malfunctioning vehicle between a first area where a number of remotely operated automated vehicles operate and a second area where human operators operate. This is achieved by providing a vehicle gate arrangement which ensures that at least one of a first shutter towards the first area, and/or a second shutter towards the second area, is in an obstructing position at any time. In all embodiments, the first shutter only moves when the second shutter moves, i.e. the first shutter is a slave to the second shutter. Furthermore, in all embodiments, the first shutter and the second shutter move in opposite directions.

It is described a storage system comprising:
a first area comprising a framework structure comprising upright members and a two-dimensional first rail system arranged across a top of framework structure, the first rail system comprises a first set of parallel rails arranged to guide movement of vehicles in a first direction X across the top of the frame structure, and a second set of parallel rails arranged perpendicular to the first set of rails to guide movement of the vehicles in a second direction Y across the top of the framework structure that is perpendicular to the first direction, the first and second sets of parallel rails dividing the first rail system into a plurality of access openings in the first rail system for allowing lifting and lowering of a storage container between a position above the first rail system and a position below the first rail system;
a vehicle operable on the first rail system, wherein the vehicle comprises a first set of wheels for driving in the first direction X and a second set of wheels for driving in the second direction Y;
a second area comprising a second rail system; and
a vehicle gate arrangement for controlling passage of the vehicle between the first area and the second area via a connecting rail system, wherein the vehicle gate arrangement comprises:
   a space for accommodating the vehicle;
   a first shutter for separating the space and the first area; and
   a second shutter for separating the space and the second area;
wherein both the first shutter and the second shutter are each actuatable between:
   an open position which allows passage of the vehicle therethrough; and
   an obstructing position which restricts passage of the vehicle therethrough; and
      wherein the first shutter and the second shutter are coupled to each other for synchronous movement such that one shutter moves in one direction with respect to a first opening and the other shutter moves in an opposite direction with respect to a second opening, and wherein the first shutter and/or the second shutter is in the respective obstructing position at any time.

I.e., at least one of the first shutter or the second shutter is in the obstructing position at any time. In other words, both the first shutter and the second shutter cannot be in the open position at the same time. The first shutter may be configured to allow or prevent passage of a vehicle through a first through-pass opening of the vehicle gate arrangement towards the first area. Similarly, the second shutter may be configured to allow or prevent passage of a vehicle through a second through-pass opening of the vehicle gate arrangement towards the second area. Dependent on the design of the first and second shutter relative to the first and second through-pass opening of the vehicle gate arrangement they are intended to allow or prevent passage through, the first and second shutters will normally be in the obstructing position. Typically, it is only when the first and second shutters reach an end point of travel that they are in the open position. In all other positions between said end point of travel and to an opposite end point of travel, the first and second shutter are in the obstructing position.

The idea is to provide a vehicle gate arrangement where two shutters or locked gates form a space therebetween, and wherein the shutters are mechanically linked to each other in a configuration such that upon movement of one shutter, the other door moves simultaneously/synchronously in an opposite direction. Furthermore, the mechanical link between the shutters is such that if one of the shutters is in an open position, the other shutter must be in the obstructing position for safety reasons in order to prevent that vehicles or operators accidently move between the first are and the second area (and between the second area and the first area). In operation, if one of the shutters are operated from the obstructing position to an open position, the other shutter automatically follows the movement in an opposite direction.

The vehicles can be container handling vehicles with a container lifting device for lifting storage containers from above, or a container handling vehicle which can support a storage container from below. Alternatively, the vehicle can be a service vehicle for rescuing and/or inspecting malfunctioning a container handling vehicle.

The second rail system may have a similar rail system as the first rail system, i.e. the second rail system may comprise a first set of parallel rails arranged to guide movement of vehicles in a first direction X across the top of the frame structure, and a second set of parallel rails arranged perpendicular to the first set of rails to guide movement of the vehicles in a second direction Y across the top of the frame structure that is perpendicular to the first direction X, the first and second sets of parallel rails dividing the first rail system into a plurality of access openings in the second rail system.

The first area can be a storage area and the second area can be a service area. In the storage area, a number of remotely operated vehicles operate and this area is restricted for manual operators unless the storage system is shut down completely. In the service area, human operators operate, e.g. to repair malfunctioning vehicles.

A top surface of the first rail system, the second rail system and the connecting rail system may be flush with one another. I.e. the respective top surfaces of the first rail system, the second rail system and the connecting rail system may be at the same level.

The connecting rail system may form part of the first rail system. In other words, the first rail system may comprise the connecting rail system. Alternatively, the connecting rail system may form part of the second rail system. In either case, the vehicle gate arrangement may be fastened or fixed to the connecting rail system.

In yet another alternative, the connecting rail system may be a dedicated rail system and form part of the vehicle gate arrangement. In this alternative, the vehicle gate arrangement together with the connecting rail system may be connected to the first and/or second rail system.

At least a portion of the first shutter and the second shutter may move in a vertical direction between the open position and the obstructing position. I.e. the movement of the first and second shutters may have a vertical component. This can be achieved in different ways, e.g. by only vertical movement where the first and second shutters move only in the vertical direction, or by a partly vertical and inclined or horizontal movement.

The first shutter and the second shutter can be counter-balanced. For an effective counter-balancing, the first shutter and the second shutter may preferably have the same or substantially the same weight such that any force required to lift or lower the parts are minimal.

The first shutter and the second shutter can be connected via a movement transferring arrangement. The movement transferring arrangement may comprise lines and pulley(s)/sheave(s). The lines may e.g. be wires, ropes and/or bands which are guided over the pulley(s) or sheave(s).

The first shutter and the second shutter and the movement transferring arrangement may provide a shutter assembly. A lower end of one of the first or second shutters may move up as the lower end of the other of the first or second shutter move down.

A travel distance for a pair of lines of the movement transferring arrangement between the first shutter and the second shutter may be the same in all operational positions of the first shutter and the second shutter. This means that a distance between the first shutter and the second shutter may be the same in all operational positions of the first shutter and the second shutter.

The movement transferring arrangement may comprise an endless loop and the first shutter and the second shutter may be connected to the endless loop.

The first shutter and the second shutter can be connected to one or more actuators for simultaneous operation of the first shutter and the second shutter. The one or more actuator(s) may be operated for opposite movement of the first and second shutters. For example, the one or more actuator(s) may comprise a first chamber and a second chamber where the first chamber is connected to the first shutter for operation of the first shutter and the second chamber is connected to the second shutter for operation of the second shutter. Pressurizing of the first chamber or the second chamber may operate the first shutter and the second shutter between its respective open position and obstructing position.

The first shutter and the second shutter may form opposite end portions of a shutter assembly formed by hinged panels. The first and second shutter may form two parts of a continuous roller shutter, e.g. a rollover shutter, with horizontal hinges between panels of the continuous roller shutter. The shutter assembly may be arranged such that a lower end of one of the first or second shutters may move up as the lower end of the other of the first or second shutter move down.

The hinged panels may render possible that one portion of the gate can pivot a number of degrees relative a neighbor portion of the gate. For example, the portions of the gate can pivot in the range of 20 to 180 degrees relative each other, or more preferably in the range of 20 to 90 degrees relative each other.

The vehicle gate arrangement may be arranged at or close to a perimeter of the first area. Arranging the vehicle gate arrangement at the perimeter may free up space for e.g. storage in the storage area and may ease access to the second area (e.g. service area).

The space of the vehicle gate arrangement preferably extends over at least two access openings. In other words, the size of the space should at least be access openings (including width of tracks) in order to accommodate all regular sized vehicles.

Similarly, the vehicle gate arrangement may comprise a first and a second opening toward the first area and the second area, respectively, and the first shutter may be configured to obstruct the first opening and the second shutter may be configured to obstruct the second opening. The first and second openings are also preferably sized with width and height dimensions dependent on the largest vehicles expected to pass therethrough. In most cases, it will be sufficient that the width of the openings is somewhat larger than one access opening (including width of tracks) and the height of the openings is somewhat higher than the largest vehicles expected to pass therethrough.

It is further described a vehicle gate arrangement for controlling passage of a vehicle between a first area having a first rail system and a second area having a second rail system via a connecting rail system, wherein the vehicle gate arrangement comprises:
a space for accommodating the vehicle;
a first shutter for separating the space and the first area;
a second shutter for separating the space and the second area;
   wherein both the first shutter and the second shutter are actuatable between:
an open position which allows passage of the vehicle therethrough; and
an obstructing position which restricts passage of the vehicle therethrough; and
   wherein the first shutter and the second shutter are coupled to each other for synchronous movement such that one shutter moves in one direction with respect to a first opening and the other shutter moves in an opposite direction with respect to a second opening, and wherein the first shutter and/or the second shutter is in the obstructing position at any time.

At least a portion of the first shutter and the second shutter may move in a vertical direction between the open position and the obstructing position.

The first shutter and the second shutter may be counter-balanced.

It is further described a method of moving a vehicle in need of service between a first area and a second area of a storage system as defined above, wherein the method comprises:
operating the control system to instruct the vehicle operating on the first area to drive to the first shutter of the vehicle gate arrangement;
ensuring that the first shutter is in the open position such that the vehicle can enter the space of the vehicle gate arrangement;
instructing the control system to open a lock which secures the second shutter in the obstructing position;
operating the second shutter from the obstructing position to the open position and thus consequently operating the first shutter from the open position to the obstructing position;
operating the control system to instruct the vehicle to drive from the space and into the second area;
operating the second shutter from the open position to the obstructing position and thus consequently operating the first shutter from the obstructing position to the open position.

The steps of operating the second shutter may be performed manually by a human operator. Manual operation can be via a handle on the second shutter. The handle or similar is preferably directed towards the second area for secure operation thereof.

Alternatively, the second shutter can be operated via a control panel or activation button arranged in the proximity of the second shutter. The activation button may be operating a motor which operates the second shutter between the open position and the obstructing position (and consequently the first shutter).

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the storage system and the goods to be stored. The gripping recesses may be arranged at an upper rim of the sidewalls. The outer horizontal periphery of the storage container is preferably rectangular.

The storage system, vehicle gate arrangement and methods may be used in connection with storage containers and systems as described above. However, other areas where the disclosed storage system and methods may be used is within vertical farming, micro-fulfilment or grocery/e-grocery.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4A is a perspective view, seen from below, of a prior art container handling vehicle having an internally arranged cavity for carrying storage containers therein;

FIG. 4B is a perspective view of a prior art container handling vehicle in the form of a delivery vehicle with a container carrier and which can support a storage container from below;

FIGS. 5A-5K are different views of a first embodiment of a storage system where the first shutter and the second shutter of a vehicle gate arrangement move in a vertical direction across a pair of openings, each between an open position which allows passage of a vehicle therethrough and an obstructing position which restricts passage of a vehicle therethrough, and where in particular:

FIG. 5A is a side perspective view seen from the side of a first area of the storage system in a direction towards the vehicle gate arrangement and a second area, and where the first shutter is in the open position and the second shutter is in the obstructing position, and a vehicle operating on the first area is positioned adjacent the first shutter about to enter a space of the vehicle gate arrangement;

FIG. 5B is a side perspective view from the opposite side compared to the view in FIG. 5A, i.e. the view in FIG. 5B is seen from the side of the second area of the storage system in a direction towards the vehicle gate arrangement and the first area;

FIG. 5C is a side perspective view seen from the side of a first area of the storage system in a direction towards the vehicle gate arrangement and a second area, and where the first shutter is in the open position and the second shutter is in the obstructing position, and the vehicle operating on the first area has entered the space of the vehicle gate arrangement;

FIG. 5D is a side perspective view from the opposite side compared to the view in FIG. 5C, i.e. the view in FIG. 5D is seen from the side of the second area of the storage system in a direction towards the vehicle gate arrangement and the first area;

FIG. 5E is a side perspective view seen from the side of a first area of the storage system in a direction towards the vehicle gate arrangement and a second area, and where the first shutter is in the obstructing position and the second shutter is about to enter the open position, and the vehicle is still accommodated in the space of the vehicle gate arrangement;

FIG. 5F is a side perspective view from the opposite side compared to the view in FIG. 5E, i.e. the view in FIG. 5F is seen from the side of the second area of the storage system in a direction towards the vehicle gate arrangement and the first area;

FIG. 5G is a side perspective view seen from the side of a first area of the storage system in a direction towards the vehicle gate arrangement and a second area, and where the first shutter is in the obstructing position and the second shutter is in the open position, and the vehicle is still accommodated in the space of the vehicle gate arrangement;

FIG. 5H is a side perspective view from the opposite side compared to the view in FIG. 5G, i.e. the view in FIG. 5H is seen from the side of the second area of the storage system in a direction towards the vehicle gate arrangement and the first area;

FIG. 5I is a side perspective view seen from the side of the second area of the storage system in a direction towards the vehicle gate arrangement and the first area, and where the second shutter is in the obstructing position and the first shutter is in the open position, and wherein the vehicle which was accommodated in the space has moved into the second area,

FIG. 5J is a side view of a storage system, the storage system comprising: the first area with a first rail system, the vehicle gate arrangement with a connecting rail system and the second area with a second rail system, where in FIG. 5J the first shutter is in the obstructing position whereas the second shutter is in the open position;

FIG. 5K is a top view of the storage system in FIG. 5J;

FIG. 6 is a detailed view of the vehicle gate arrangement in FIGS. 5A-5K;

FIG. 7 is a detailed view of a second embodiment where the vehicle gate arrangement comprises a first shutter and a second shutter which form opposite end portions of a vehicle gate arrangement comprising a shutter assembly formed by hinged panels;

FIG. 8 is a detailed view of a third embodiment where the first and second shutters are suspended on opposite sides of a central pivot;

FIG. 9 is a top view of a fourth embodiment where the first and second shutters are connected to an endless loop and move sideways between the open position and the obstructing position respectively.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

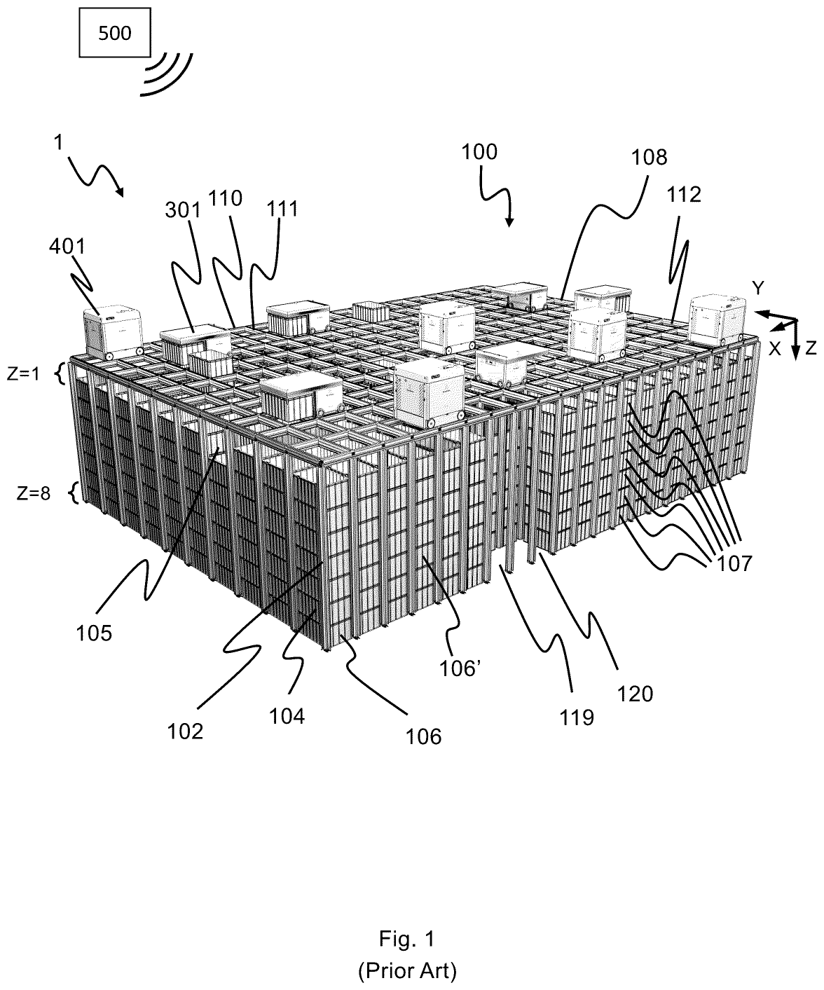

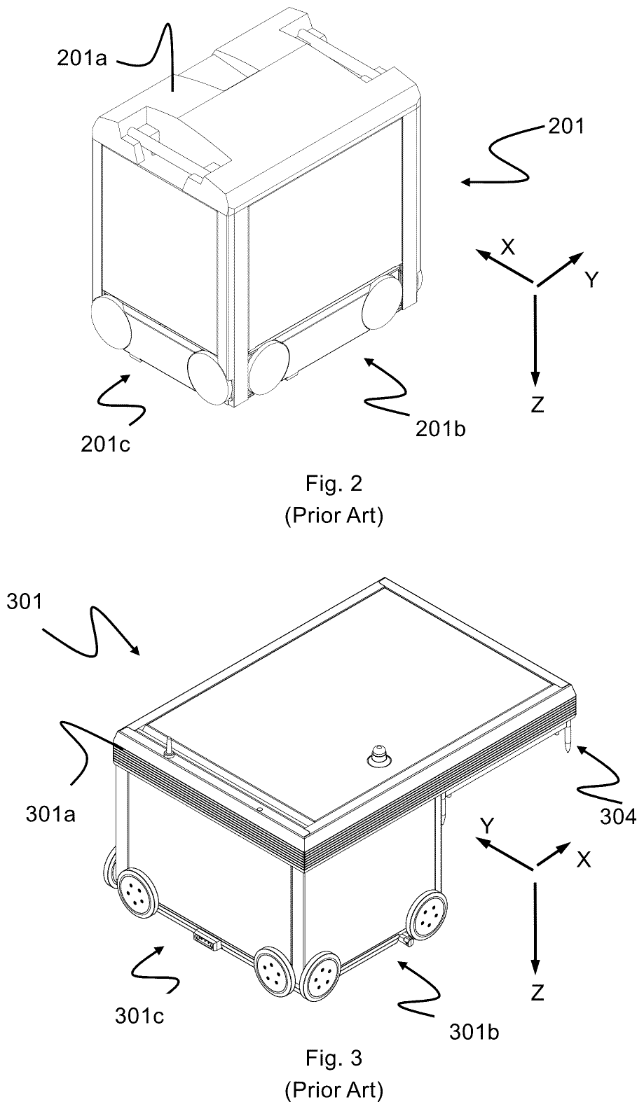

A framework structure 100 of the automated storage and retrieval system 1 may be constructed in a similar manner to the prior art framework structure 100 described above in connection with FIGS. 1-3. That is, the framework structure 100 may comprise a number of upright members 102, and comprise a first, upper rail system 108 extending in the X direction and Y direction.

The framework structure 100 may further comprise storage compartments in the form of storage columns 105 provided between the members 102 wherein storage containers 106 may be stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

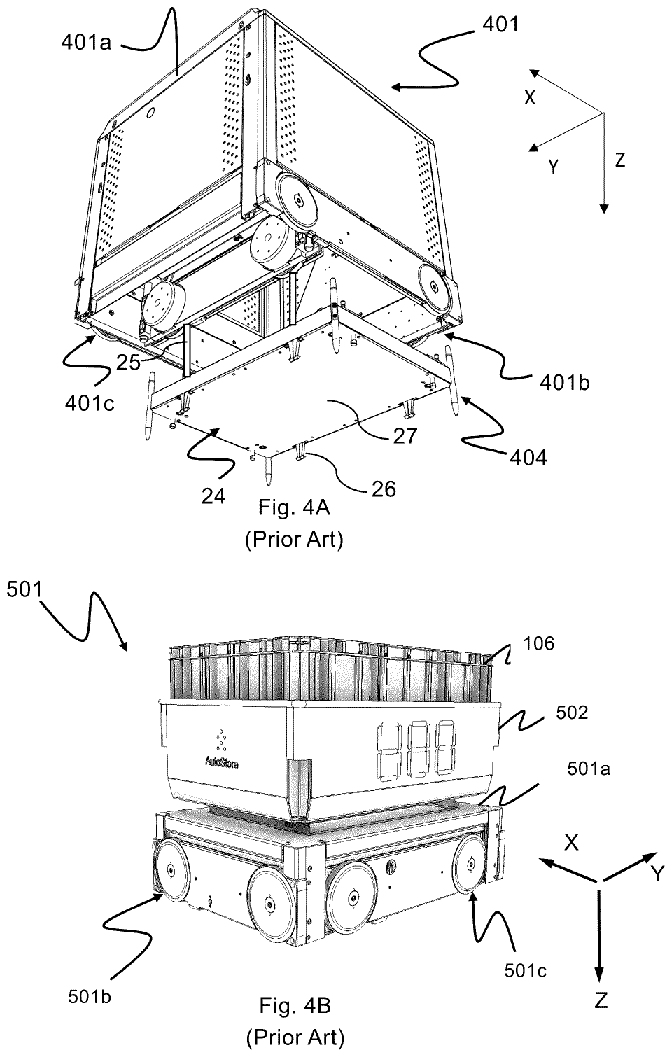

FIG. 4B is a perspective view of a prior art container handling vehicle 501 in the form of a delivery vehicle 501 with a container carrier 502 which can support a storage container 106 from below. The delivery vehicle 501 features a vehicle body 501a and first and second sets of wheels 501b, 501c which enable the lateral movement of the delivery vehicle 501 in the X direction and in the Y direction on the rail system 108, respectively.

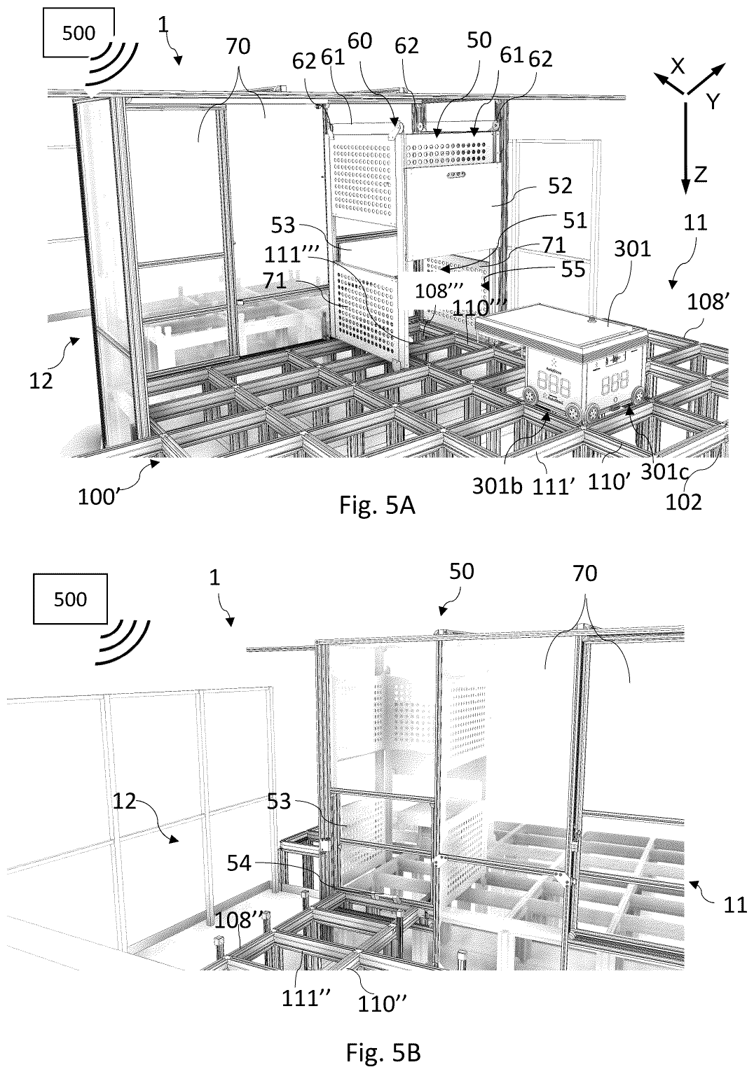

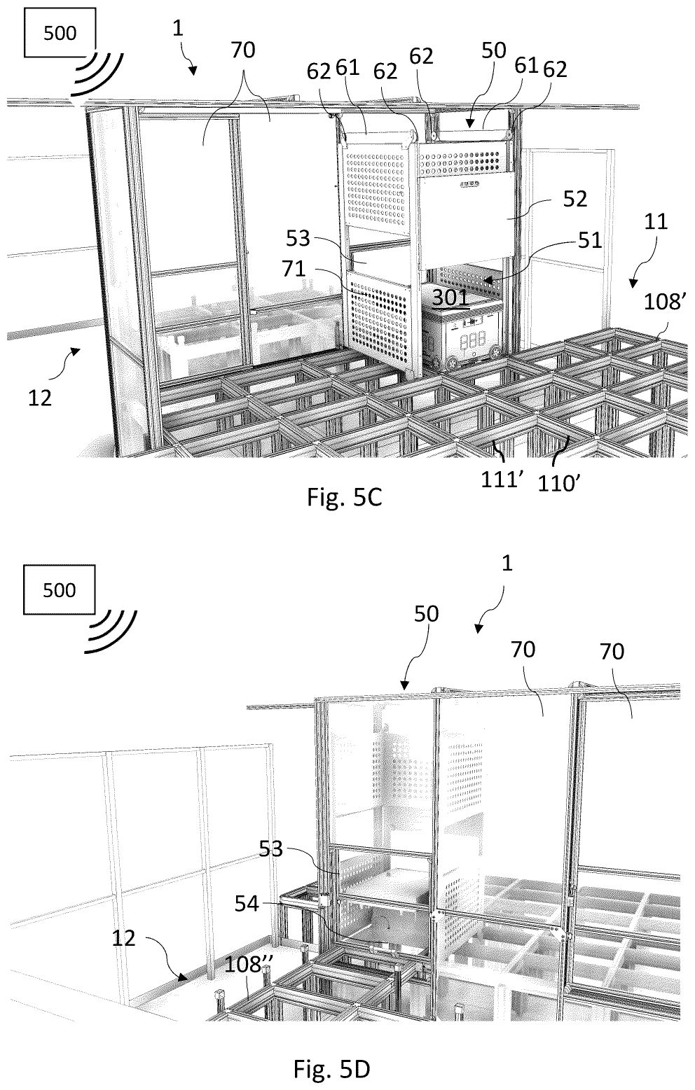

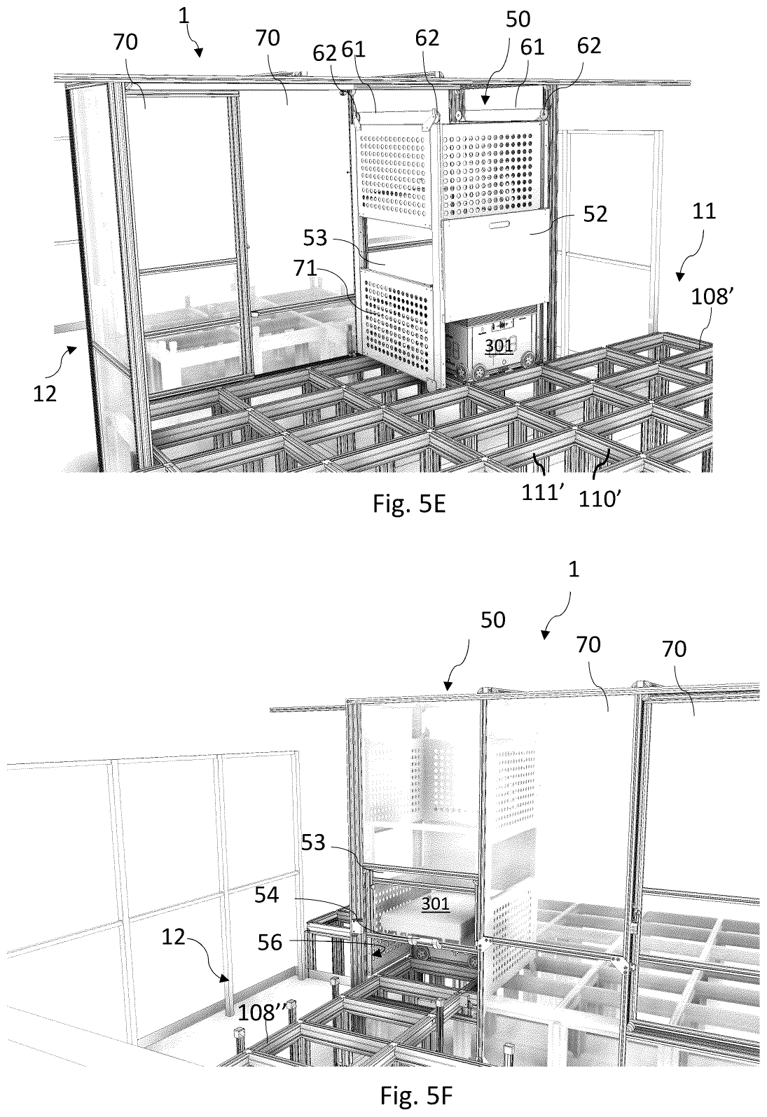

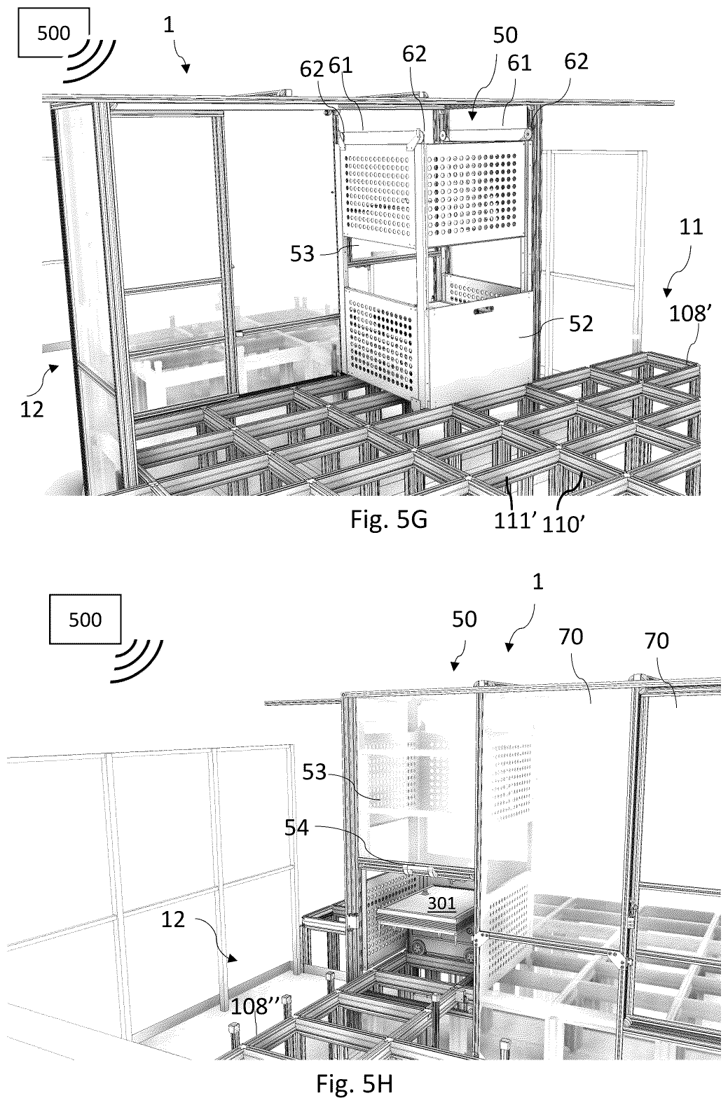

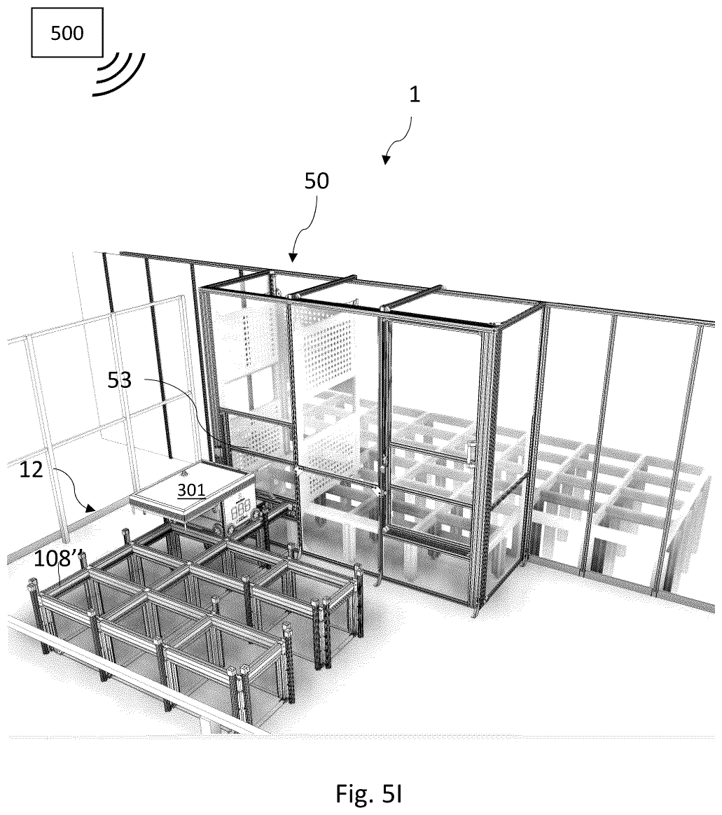

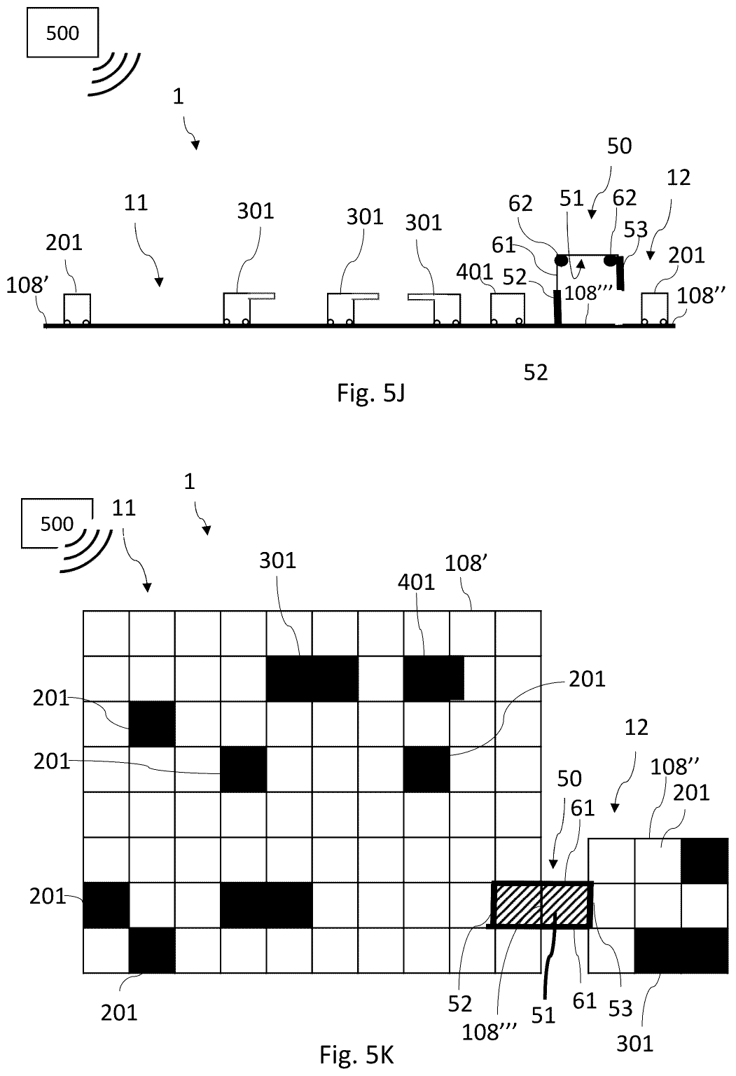

FIGS. 5A-5K are different views of a first embodiment of a storage system 1 where the first shutter 52 and the second shutter 53 of a vehicle gate arrangement 50 move with respect to the openings only in a vertical direction, each shutter 52,53 moving between an open position which allows passage of a vehicle 301 therethrough and an obstructing position which restricts passage of a vehicle 301 therethrough.

FIG. 5A is a side perspective view seen from the side of a first area 11 of the storage system 1 in a direction towards the vehicle gate arrangement 50 and a second area 12, and where in FIG. 5A the first shutter 52 is in the open position and the second shutter 53 is in the obstructing position, and a vehicle 301 operating on the first area 11 is positioned adjacent the first shutter 52 about to enter a space 51 of the vehicle gate arrangement 50.

FIG. 5B is a side perspective view from the opposite side compared to the view in FIG. 5A, i.e. the view in FIG. 5B is seen from the side of the second area 12 of the storage system 1 in a direction towards the vehicle gate arrangement 50 and the first area 11.

Referring to FIGS. 5A and 5B, the first area 11 is disclosed formed of a framework structure 100′ comprising upright members 102 and a two-dimensional first rail system 108′ arranged across the top of framework structure 100′. The first rail system 108′ comprises a first set of parallel rails 110′ arranged to guide movement of a vehicle 301 in a first direction X across the top of the frame structure 100′, and a second set of parallel rails 111′ arranged perpendicular to the first set of rails 110′ to guide movement of the vehicle 301 in a second direction Y across the top of the frame structure 100′ that is perpendicular to the first direction. The first and second sets of parallel rails 110′,111′ dividing the first rail system 108′ into a plurality of access openings 112 in the first rail system 108′ allowing for lifting and lowering of a storage container 106 between a position above the first rail system 108′ and a position below the first rail system 108′. The vehicle 301 is operable on the first rail system 108′ and comprises a first set of wheels 301b for driving in the first direction X and a second set of wheels 301c for driving in the second direction Y. It is further disclosed a second area 12 separated from the first area 11 by the vehicle gate arrangement 50 and window panels 70. The second area 12 comprising a second rail system 108″. The second rail system 108″ has a similar rail system as the first rail system 108′, i.e. the second rail system 108″ is shown with a first set of parallel rails 110″ arranged to guide movement of vehicles in a first direction X across the top of the frame structure, and a second set of parallel rails 111″ arranged perpendicular to the first set of rails 110″ to guide movement of the vehicles in a second direction Y which is perpendicular to the first direction X.

As seen, a top surface of the first rail system 108′, the second rail system 108″ and the connecting rail system 108′″ are flush with one another. I.e. the respective top surfaces of the first rail system 108′, the second rail system 108″ and the connecting rail system are at the same level such that the vehicle 301 can move self-propelled between the first area 11 and the second area 12.

The vehicle gate arrangement 50 controls passage of the vehicle 301 between the first area 11 and the second area 12. As shown in FIG. 5A, the vehicle gate arrangement 50 has a space 51 for accommodating the vehicle 301. The space 51 is dimensioned based on the size of the vehicles 201,301,401,501 to pass therethrough. The space 51 is of a sufficient size to accommodate the prior art container handling vehicle 301 with cantilever. Thus, the space 51 of the vehicle gate arrangement 50 extends over at least two access openings (including width of tracks) in order to accommodate all regular sized vehicles (such as the prior art container handling vehicle 301 with cantilever).

The vehicle gate arrangement 50 comprises a first shutter 52 for separating the space 51 and the first area 11 and a second shutter 53 for separating the space 51 and the second area 12. The first shutter 52 can block or obstruct (restrict) passage through a first opening 55 and the second shutter 53 can block or obstruct (restrict) passage through a second opening 56 opening (not shown in FIGS. 5A,5B, see e.g. FIG. 5F). The height and width of the first and second openings 55,56 are dependent on the largest vehicles 201,301,401,501 expected to pass therethrough. In most cases, it will be sufficient that the width of the openings 55,56 is somewhat larger than one access opening (including width of tracks) and the height of the first and second openings 55,56 is somewhat higher than the largest vehicles 201,301,401,501 expected to pass therethrough.

As described above, in FIGS. 5A and 5B, the first shutter 52 is in the open position and the second shutter 53 is in obstructing position. Both the first shutter 52 and the second shutter 53 are actuatable between an open position which allows passage of the vehicle 201,301,401,501 therethrough, and an obstructing position which restricts passage of the vehicle 201,301,401,501 therethrough. However, at least one of the first shutter 52 and the second shutter 53 is in an obstructing position at any time.

The first shutter 52 and the second shutter 53 are coupled to each other for synchronous movement, such that as one shutter 52,53 moves in one direction across an opening, the other shutter 53,52 moves in an opposite direction across its opening.

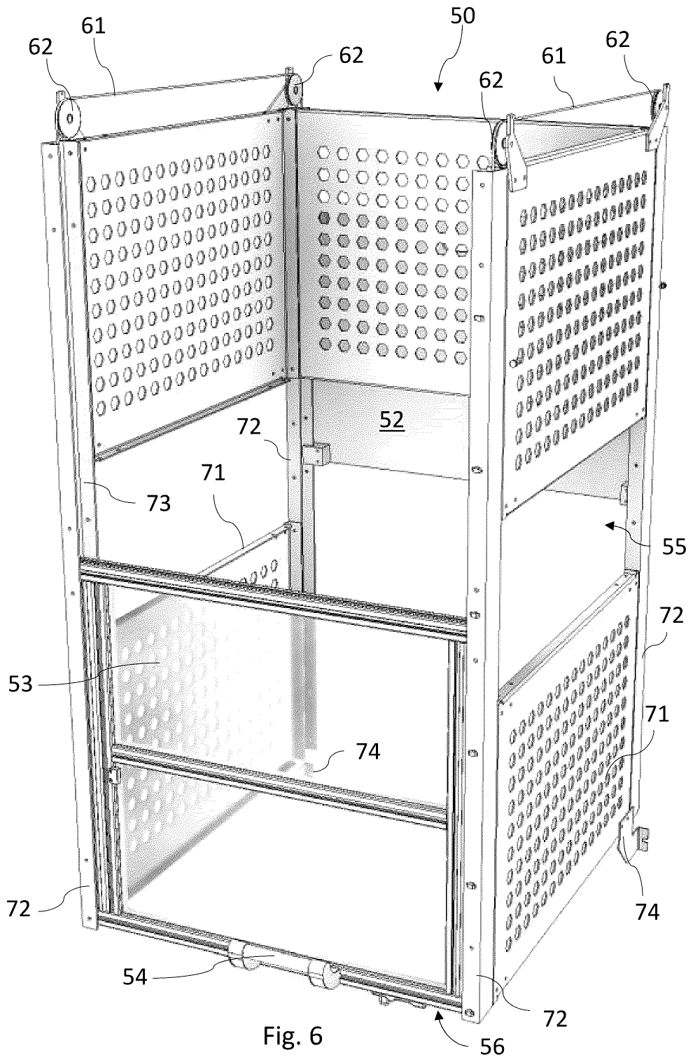

The first and second shutters 52,53 may have a rectangular shape and be configured to move in the vertical direction. The vertical travel distance for the shutters 52,53 is based on the height of the vehicles 201,301,401, 501 to pass therethrough. Similarly, the total height of the vehicle gate arrangement 50 will also be dependent on the space required for the vertical travel distance to be possible. Due to the vertical travel of the first and second shutters 52,53, the height of the vehicle gate arrangement 50 in FIGS. 5A-5K and 6 needs to be at least twice the height as the first and second shutters 52,53.

The first and second shutters 52,53 of FIGS. 5A-5K and 6 are coupled to each other via a movement transferring arrangement 60 in the form of lines 61 and pulleys 62. As shown in FIG. 5A, two lines 61 are connected at upper corners of the respective rectangular shaped first and second shutters 52,53 and each line 61 is guided over two pulleys 62. Furthermore, the space 51 of the vehicle gate arrangement 50 in FIGS. 5A-5K and 6 is closed by panels 71 on each side to prevent that a vehicle 201,301,401,501 enters or exits the space 51 unintentionally.

FIG. 5C is a side perspective view seen from the side of a first area 11 of the storage system 1 in a direction towards the vehicle gate arrangement 50 and a second area 12, and where in FIG. 5C the first shutter 52 is in the open position and the second shutter 53 is in the obstructing position, and the vehicle 301 operating on the first area 11 has entered the space 51 of the vehicle gate arrangement 50.

FIG. 5D is a side perspective view from the opposite side compared to the view in FIG. 5C, i.e. the view in FIG. 5D is seen from the side of the second area 12 of the storage system 1 in a direction towards the vehicle gate arrangement 50 and the first area 11.

FIG. 5E is a side perspective view seen from the side of a first area 11 of the storage system 1 in a direction towards the vehicle gate arrangement 50 and a second area 12, and where in FIG. 5E the first shutter 52 is in the obstructing position and the second shutter 53 is about to enter the open position, and the vehicle 301 is still accommodated in the space 51 of the vehicle gate arrangement 50.

FIG. 5F is a side perspective view from the opposite side compared to the view in FIG. 5E, i.e. the view in FIG. 5F is seen from the side of the second area 12 of the storage system 1 in a direction towards the vehicle gate arrangement 50 and the first area 11. In order to move the second shutter 53 to the open position (and thus the first shutter 52 to the obstructing position), a human operator (not shown) has operated the handle 54 and lifted the second shutter 53 upwards. Based on the fact that the first and second shutters in FIGS. 5A and 6 are counter-balanced, by means of the movement transferring arrangement 60 comprising lines 61 and pulleys 62, the required force to raise the second shutter 53 upwards is reduced.

FIG. 5G is a side perspective view seen from the side of a first area 11 of the storage system 1 in a direction towards the vehicle gate arrangement 50 and a second area 12, and where in FIG. 5G the first shutter 52 is in the obstructing position and the second shutter 53 is in the open position, and the vehicle 301 is still accommodated in the space 51 of the vehicle gate arrangement 50.

FIG. 5H is a side perspective view from the opposite side compared to the view in FIG. 5G, i.e. the view in FIG. 5H is seen from the side of the second area 12 of the storage system 1 in a direction towards the vehicle gate arrangement 50 and the first area 11.

FIG. 5I is a side perspective view seen from the side of the second area 12 of the storage system 1 in a direction towards the vehicle gate arrangement 50 and the first area 11, and where the second shutter 53 is in the obstructing position and the first shutter 52 is in the open position, and wherein the vehicle 301 which was accommodated in the space 51 has moved into the second area 12.

The movement of the vehicle 301 from the first area 11 via the vehicle gate arrangement 50 and to the second area 12 is through self-propelled movement on the first rail system 108′, the connecting rail system 108″ and on the second rail system 108″.

FIG. 5J is a side view of a storage system 1, the storage system 1 comprising: the first area 11 with a first rail system 108′, the vehicle gate arrangement 50 with a connecting rail system 108′″ and the second area 12 with a second rail system 108″, where in FIG. 5J the first shutter 52 is in the obstructing position whereas the second shutter 53 is in the open position.

FIG. 5K is a top view of the storage system in FIG. 5J.

FIG. 6 is a detailed view of the vehicle gate arrangement 50 in FIGS. 5A-5K. the vehicle gate arrangement 50 comprises:
the space 51 for accommodating the vehicle 201,301,401,501 (vehicle not shown in FIG. 6, see e.g. FIGS. 5C-5H),
the first shutter 52 for separating the space 51 and the first area 11 (first area not shown in FIG. 6, see FIGS. 5A-5K),
a second shutter 53 for separating the space 51 and the second area 12 (second area not shown in FIG. 6, see FIGS. 5A-5K). Both the first shutter 52 and the second shutter 53 are actuatable between an open position which allows passage of the vehicle 201,301,401,501 therethrough and an obstructing position which restricts passage of the vehicle 201,301,401,501 therethrough.

The first shutter 52 and the second shutter 53 are coupled to each other via a movement transferring arrangement 60 in the form of lines 61 and pulleys 62 to provide a shutter assembly. In this way, the first shutter 52 and the second shutter 53 maintain a constant separation during their movement between their respective open and obstructing positions. As shown in FIG. 6, two lines 61 are connected at upper corners of the respective rectangular shaped first and second shutters 52,53 and each line 61 is guided over two pulleys 62. Furthermore, the space 51 of the vehicle gate arrangement 50 in FIG. 6 is closed by panels 71 on each side to prevent that a vehicle 201,301,401,501 enters or exits the space 51 unintentionally.

Corner members 72 are arranged in the corners of the vehicle gate arrangement 50. The corner members 72 supports the panels 71 and provides support for raising and lowering of the first and second shutters 52,53. In order to guide movement of the first and second shutters 52,53, the corner members 72 may comprise a groove or recess 73 of complementary shape as side portions of the first and second shutters 52,53 to ensure vertical guiding thereof.

The vehicle gate arrangement 50 may comprise one or more fastening brackets 74 for secured fastening to underlying rail system 108′,108″,108′″ (rail system not shown in FIG. 6).

Again referring to the embodiment in FIGS. 5A-5K and 6, an operational sequence of moving a vehicle 301 in need of service between the first area 11 and the second area 12 of a storage system 1 may comprise:
operating the control system 500 to instruct the vehicle 201,301,401,501 operating on the first area 11 to drive to the first shutter 52 of the vehicle gate arrangement 50;
ensuring that the first shutter 52 is in the open position such that the vehicle 201,301,401,501 can enter the space 51 of the vehicle gate arrangement 50;
instructing the control system 500 to open a lock (not shown) which secures the second shutter 53 in the obstructing position;
operating the second shutter 53 from the obstructing position to the open position and thus consequently operating the first shutter 52 from the open position to the obstructing position;
operating the control system 500 to instruct the vehicle 201,301,401,501 to drive from the space 51 and into the second area 12;
operating the second shutter 53 from the open position to the obstructing position and thus consequently operating the first shutter 52 from the obstructing position to the open position.

The steps of operating the second shutter 53 may be performed manually by a human operator by manipulating the handle 54 on the second shutter 53.

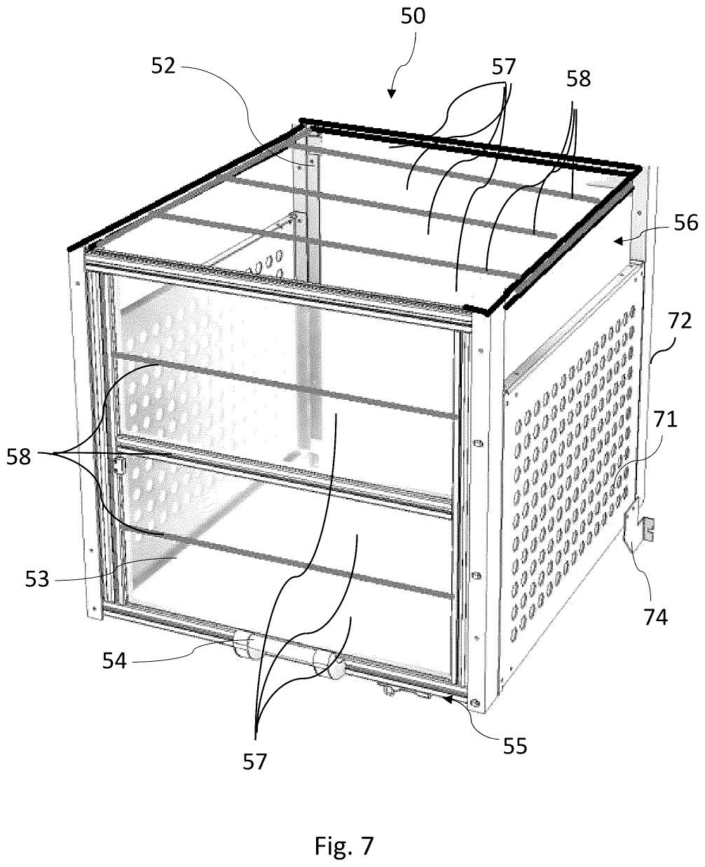

FIG. 7 is a detailed view of a second embodiment where the vehicle gate arrangement 50 comprises a first shutter 52 and a second shutter 53 which form opposite end portions of a shutter assembly formed by hinged panels 57. The shutter assembly may be arranged such that a lower end of one of the first or second shutters 52;53 may move up as the lower end of the other of the first or second shutter 53;52 move down.

In this embodiment, the first and second shutter 52,53 form two parts of a continuous roller shutter, e.g. a rollover shutter, with horizontal hinges 58 between panels 57 of the continuous roller shutter. In this way, the first shutter 52 and the second shutter 53 maintain a constant separation during their movement between their respective open and obstructing positions.

Similar to the embodiment in FIG. 6, the vehicle gate arrangement in FIG. 7 may have corner members 72 arranged in the corners of the vehicle gate arrangement 50. The corner members 72 supports the panels 71 and provides support for raising and lowering of the first and second shutters 52,53. In order to guide movement of the first and second shutters 52,53, the corner members 72 may comprise a groove or recess 73 (not shown in FIG. 7, see e.g. FIG. 6) of complementary shape as side portions of the first and second shutters 52,53 to ensure vertical guiding thereof. The shutter also has a handle 54 for operation by a human operator. In addition, the vehicle gate arrangement 50 may have one or more fastening brackets 74 for secured fastening to underlying rail system 108′,108″,108′″ (rail system not shown in FIG. 7).

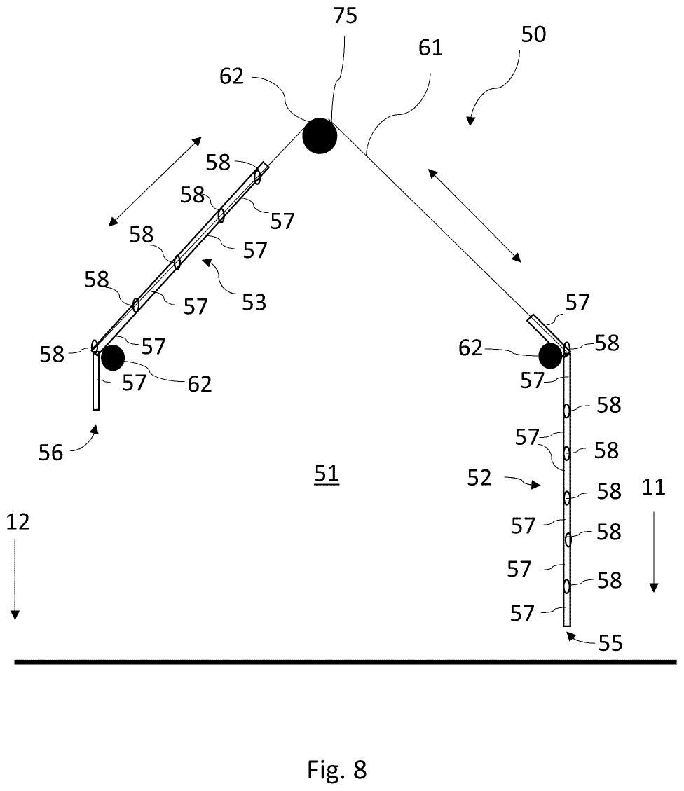

FIG. 8 is a detailed view of a third embodiment where the first and second shutters 52,53 are suspended from the same line 61 extending over a central pivot 75 (the central pivot 75 coinciding with the pulley 62 in FIG. 8). This setup provides a counter-balance effect of the first and second shutters 52,53 similar to the embodiment in FIGS. 5A-5K, 6, because the first and second shutters 52,53 are of similar size and are arranged on opposite sides of the central pivot 75. A set of two pulleys 62 are arranged at a lower elevation than the pulley 62 coinciding with the central pivot 75 for guiding the line 61 (and thus the first and second shutters 52,53) towards the central pivot 75. The first and second shutters 52,53 in FIG. 8 are formed by panels 57 with horizontal hinges 58 between the panels 57 which provides for the possibility that the first and second shutters 52,53 can be guided over the lower two pulleys 62. In this way, the first shutter 52 and the second shutter 53 maintain a constant separation during their movement between their respective open and obstructing positions.

Compared to the embodiment in FIGS. 5A-5K, 6, the embodiment in FIG. 8 provides for the possibility of a lower vehicle gate arrangement 50 because the first and second shutters 52,53 are lifted in an inclined angle towards the central pivot 75.

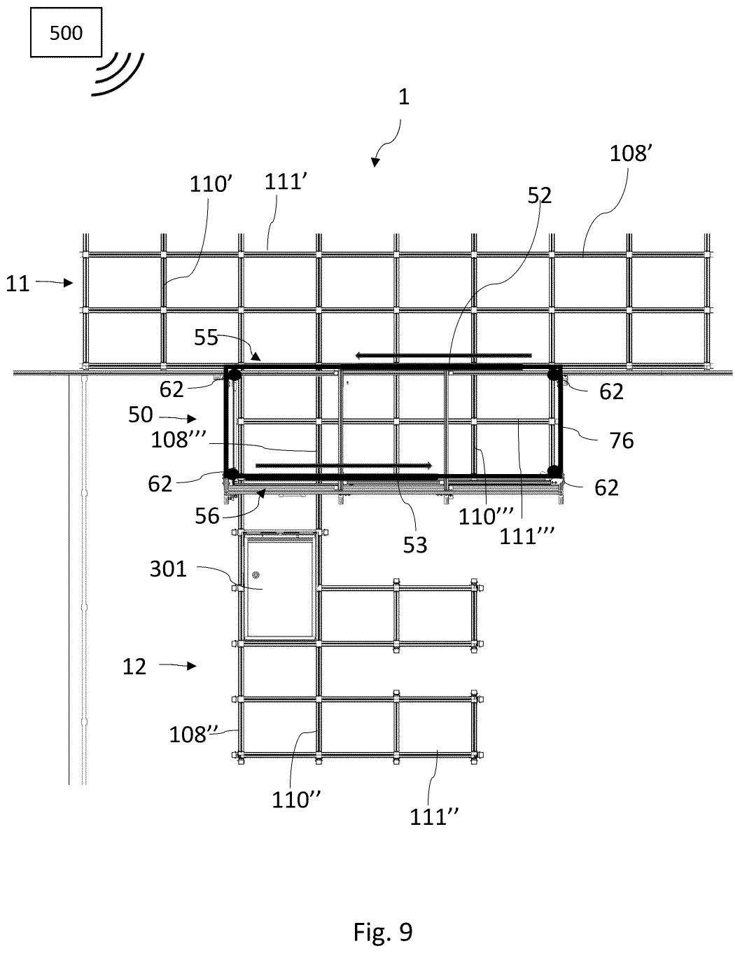

FIG. 9 is a top view of a fourth embodiment where the first and second shutter 52,53 are connected to an endless loop 76 and move sideways between the open position and the obstructing position. The first and second shutters 52,53 are connected to the same endless loop 76, thus any horizontal movement of the second shutter 53 will also move the first shutter 52 and, since the first and second shutter 52,53 are arranged on opposite sides of the space 51, the first shutter 52 will move in an opposite direction of the second shutter 53. The endless loop 76 in FIG. 9 encircles the space 51 and are guided around the space 51 by means of pulleys 62 in all our corners of the space 51.

In FIG. 9, the first shutter 52 is in the open position whereas the second shutter 53 is in the obstructing position and a vehicle 301 is positioned in the second area 12.

Although not explicitly disclosed in the embodiments of FIGS. 7, 8 and 9, features of the first area 11, the second area 12 and the first rail system 108′, the second rail system 108″ and the connecting rail system 108′″ are similar to the features described in relation to FIGS. 5A-5K, 6.

In the preceding description, various aspects of the storage system, vehicle gate arrangement and method according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

LIST OF REFERENCE NUMBERS

| | |
|---|---|
| 1 | Prior art automated storage and retrieval system |
| 11 | First area |
| 12 | Second area |
| 24 | Lifting device |
| 25 | Lifting bands |
| 26 | Gripping engaging device |
| 27 | Lifting frame |
| 28 | Gripping recess for gripping engaging device |
| 50 | Vehicle gate arrangement |
| 51 | Space |
| 52 | First shutter |
| 53 | Second shutter |
| 54 | Handle |
| 55 | First opening |
| 56 | Second opening |
| 57 | Hinged panel |
| 58 | Hinge |
| 60 | Movement transferring arrangement |
| 61 | Lines/Wire/rope/band |
| 62 | Pulley/sheave |
| 70 | Window panel |
| 71 | panel |
| 72 | Corner member |
| 73 | Groove/recess |
| 74 | Bracket |
| 75 | Central pivot |
| 76 | Endless loop |
| 106′ | Particular position of storage container |
| 107 | Stack |
| 108 | Rail system |
| 108′ | First rail system |
| 108″ | Second rail system |
| 108′″ | Connecting rail system |
| 110, 110′, 110″, 110′″ | Parallel rails in first direction (X) |
| 111, 111′, 111″, 111′″ | Parallel rails in second direction (Y) |
| 112 | Access opening |
| 119 | First port column |
| 120 | Second port column |
| 201 | Prior art container handling vehicle |
| 201a | Vehicle body of the container handling vehicle |
| | 201 |
| 201b | Drive means/wheel arrangement/first set of |
| | wheels in first direction (X) |
| 201c | Drive means/wheel arrangement/second set of |
| | wheels in second direction (Y) |
| 301 | Prior art cantilever container handling vehicle |
| 301a | Vehicle body of the container handling vehicle |
| | 301 |
| 301b | Drive means/first set of wheels in first direction |
| | (X) |
| 301c | Drive means/second set of wheels in second |
| | direction (Y) |
| 401 | Prior art container handling vehicle |
| 401a | Vehicle body of the container handling vehicle |
| | 401 |
| 401b | Drive means/first set of wheels in first direction |
| | (X) |
| 401c | Drive means/second set of wheels in second |
| | direction (Y) |
| 501 | Prior art delivery vehicle |
| 501a | Vehicle body of the delivery vehicle 501 |
| 501b | Drive means/first set of wheels in first direction |
| | (X) |
| 501c | Drive means/second set of wheels in second |
| | direction (Y) |
| 502 | Container carrier |
| X | First direction |
| Y | Second direction |
| Z | Third direction |

1. A storage system comprising:
a first area comprising a framework structure comprising upright members and a two-dimensional first rail system arranged across a top of framework structure, the first rail system comprises a first set of parallel rails arranged to guide movement of vehicles in a first direction across the top of the frame structure, and a second set of parallel rails arranged perpendicular to the first set of rails to guide movement of the vehicles in a second direction across the top of the framework structure that is perpendicular to the first direction, the first and second sets of parallel rails dividing the first rail system into a plurality of access openings in the first rail system for allowing lifting and lowering of a storage container between a position above the first rail system and a position below the first rail system;
a vehicle operable on the first rail system, wherein the vehicle comprises a first set of wheels for driving in the first direction and a second set of wheels for driving in the second direction;
a second area comprising a second rail system; and
a vehicle gate arrangement for controlling passage of the vehicle between the first area and the second area via a connecting rail system,
wherein the vehicle gate arrangement comprises:
a space for accommodating the vehicle;
a first shutter for separating the space and the first area; and
a second shutter for separating the space and the second area;
wherein both the first shutter and the second shutter are each actuatable between:
an open position which allows passage of the vehicle therethrough; and
an obstructing position which restricts passage of the vehicle therethrough; and
wherein the first shutter and the second shutter are coupled to each other for synchronous movement such that one shutter moves in one direction with respect to a first opening and the other shutter moves in an opposite direction with respect to a second opening, and wherein the first shutter and/or the second shutter is in the respective obstructing position at any time.

2. The storage system according to claim 1, wherein the first area is a storage area and the second area is a service area.

3. The storage system according to claim 1, wherein a top surface of the first rail system, the second rail system and the connecting rail system are flush with one another.

4. The storage system according to claim 1, wherein the connecting rail system forms part of the first rail system.

5. The storage system according to claim 1, wherein at least a portion of the first shutter and the second shutter move in a vertical direction between the open position and the obstructing position.

6. The storage system according to claim 5, wherein the first shutter and the second shutter are counter-balanced.

7. The storage system according to claim 1, wherein the first shutter and the second shutter are connected via a movement transferring arrangement.

8. The storage system according to claim 7, wherein the movement transferring arrangement comprises lines and pulley(s)/sheave(s).

9. The storage system according to claim 8, wherein a travel distance for a pair of lines is the same in all operational positions of the first shutter and the second shutter.

10. The storage system according to claim 7, wherein the movement transferring arrangement comprises an endless loop and wherein the first shutter and the second shutter are connected to the endless loop.

11. The storage system according to claim 1, wherein the first shutter and the second shutter are connected to one or more actuators for simultaneous operation of the first shutter and the second shutter.

12. The storage system according to claim 1, wherein the first shutter and the second shutter form opposite end portions of a shutter assembly formed by hinged panels.

13. The storage system according to claim 1, wherein the vehicle gate arrangement is arranged at or close to a perimeter of the first area.

14. The storage system according to claim 1, wherein the space extends over at least two access openings.

15. A vehicle gate arrangement for controlling passage of a vehicle between a first area (11) having a first rail system and a second area having a second rail system via a connecting rail system, wherein the vehicle gate arrangement comprises:
a space for accommodating the vehicle;
a first shutter for separating the space and the first area;
a second shutter for separating the space and the second area;
wherein both the first shutter and the second shutter are actuatable between:
an open position which allows passage of the vehicle therethrough; and
an obstructing position which restricts passage of the vehicle therethrough; and
wherein the first shutter and the second shutter are coupled to each other for synchronous movement such that one shutter moves in one direction with respect to a first opening and the other shutter moves in an opposite direction with respect to a second opening, and wherein the first shutter and/or the second shutter is in the obstructing position at any time.

16. The vehicle gate arrangement according to claim 15, wherein at least a portion of the first shutter and the second shutter move in a vertical direction between the open position and the obstructing position.

17. The vehicle gate arrangement according to claim 16, wherein the first shutter and the second shutter are counter-balanced.

18. A method of moving a vehicle in need of service between a first area and a second area of a storage system comprising:
a first area comprising a framework structure comprising upright members and a two-dimensional first rail system arranged across a top of framework structure, the first rail system comprises a first set of parallel rails arranged to guide movement of vehicles in a first direction across the top of the frame structure, and a second set of parallel rails arranged perpendicular to the first set of rails to guide movement of the vehicles in a second direction across the top of the framework structure that is perpendicular to the first direction, the first and second sets of parallel rails dividing the first rail system into a plurality of access openings in the first rail system for allowing lifting and lowering of a storage container between a position above the first rail system and a position below the first rail system;
a vehicle operable on the first rail system, wherein the vehicle comprises a first set of wheels for driving in the first direction and a second set of wheels for driving in the second direction;
a second area comprising a second rail system; and
a vehicle gate arrangement for controlling passage of the vehicle between the first area and the second area via a connecting rail system,
wherein the vehicle gate arrangement comprises:
a space for accommodating the vehicle;
a first shutter for separating the space and the first area; and
a second shutter for separating the space and the second area;
wherein both the first shutter and the second shutter are each actuatable between:
an open position which allows passage of the vehicle therethrough; and
an obstructing position which restricts passage of the vehicle therethrough; and
wherein the first shutter and the second shutter are coupled to each other for synchronous movement such that one shutter moves in one direction with respect to a first opening and the other shutter moves in an opposite direction with respect to a second opening, and wherein the first shutter and/or the second shutter is in the respective obstructing position at any time,
wherein the method comprises:
operating the control system to instruct the vehicle operating on the first area to drive to the first shutter of the vehicle gate arrangement;
ensuring that the first shutter is in the open position such that the vehicle can enter the space of the vehicle gate arrangement;
instructing the control system to open a lock which secures the second shutter in the obstructing position;
operating the second shutter from the obstructing position to the open position and thus consequently operating the first shutter from the open position to the obstructing position;
operating the control system to instruct the vehicle to drive from the space and into the second area;
operating the second shutter from the open position to the obstructing position and thus consequently operating the first shutter from the obstructing position to the open position.

19. The method according to claim 18, wherein an operator manually performs the operating the second shutter.
